(19) United States
(12) Patent Application Publication
(10) Pub. No.: US 2021/0159596 A1
(43) Pub. Date: May 27, 2021

(54) ELECTRONIC DEVICE COMPRISING ANTENNA

(71) Applicant: Samsung Electronics Co., Ltd., Suwon-si, Gyeonggi-do (KR)

(72) Inventors: Sung Chul PARK, Seoul (KR); Hyo Seok NA, Yongin-si (KR)

(21) Appl. No.: 16/641,847

(22) PCT Filed: Sep. 4, 2018
(86) PCT No.: PCT/KR2018/010256

§ 371 Date: Feb. 25, 2020

(30) Foreign Application Priority Data
Sep. 4, 2017 (KR) 10-2017-0112791

(51) Int. Cl. H01Q 3/32; H01Q 1/24; H01Q 3/24; H04B 7/0404; H04B 7/06

(52) U.S. Cl. CPC H01Q 3/32; H01Q 1/243; H04B 7/0602; H04B 7/0404; H01Q 3/247

(57) ABSTRACT

An electronic device includes a housing that includes a cover glass, a rear plate, and a side member, a first antenna array that is positioned adjacent to a first corner of the side member and transmits/receives a first radio frequency (RF) signal corresponding to first data, a second antenna array that is positioned adjacent to a second corner of the side member and transmits/receives a second RF signal corresponding to the first data, a third antenna array that is positioned adjacent to a third corner of the side member and transmits/receives a third RF signal corresponding to second data, a fourth antenna array that is positioned adjacent to a fourth corner of the side member and transmits/receives a fourth RF signal corresponding to the second data, and a communication module. The communication module controls at least one of the arrays such that a beam for transmitting/receiving at least one RF signal of the first, second, third, fourth RF signal is formed.

### TECHNICAL FIELD

The present disclosure relates to an electronic device including an antenna.

### BACKGROUND ART

As an information technology (IT) develops, various types of electronic devices such as a smartphone, a tablet personal computer (PC), and the like is widely being supplied. An electronic device may communicate with any other electronic device or a base station by using an antenna.

Nowadays, as the mobile traffic sharply increases, a 5th generation (5G) technology using a signal in a millimeter-wave (mmWave) frequency band is being developed. In the case where the signal in the mmWave frequency band is used, a wavelength of the signal may become shorter, and thus, the miniaturization of the antenna may be easy. Also, since the bandwidth may be used more widely, a significant amount of information may be transmitted or received.

The above information is presented as background information only to assist with an understanding of the present disclosure. No determination has been made, and no assertion is made, as to whether any of the above might be applicable as prior art with regard to the present disclosure.

### DISCLOSURE

### Technical Problem

Since the signal in the mmWave frequency band has strong straightness, the electronic device may communicate by using a beamforming technology. In the case where an mmWave-based communication technology is applied to the electronic device, due to the strong straightness, various grip types of a user may have an influence on performance of the antenna.

Aspects of the present disclosure are to address at least the above-mentioned problems and/or disadvantages and to provide at least the advantages described below. Accordingly, an aspect of the present disclosure is to provide an electronic device which reduces influence of a user's grip on performance of an antenna and transmits/receives a signal in an mmWave frequency band, by using efficient arrangement of the antenna.

### Technical Solution

In accordance with an aspect of the present disclosure, an electronic device may include a housing that includes a cover glass formed in a substantial quadrangle, a rear plate having a shape corresponding to the cover glass and facing away from the cover glass, and a side member surrounding a space between the cover glass and the rear plate, a first antenna array that is positioned adjacent to a first corner of the side member within the housing and transmits/receives a first radio frequency (RF) signal corresponding to first data, a second antenna array that is positioned adjacent to a second corner of the side member within the housing and transmits/receives a second RF signal corresponding to the first data, a third antenna array that is positioned adjacent to a third corner of the side member within the housing and transmits/receives a third RF signal corresponding to second data, a fourth antenna array that transmits/receives a fourth RF signal corresponding to the second data, and a communication module that is positioned within the housing and is electrically connected with the first antenna array, the second antenna array, the third antenna array, and the fourth antenna array. The communication module may control at least one of the first antenna array, the second antenna array, the third antenna array, and the fourth antenna array such that at least one beam for transmitting/receiving at least one RF signal of the first RF signal, the second RF signal, the third RF signal, and the fourth RF signal is formed.

### Advantageous Effects

According to various embodiments of the present disclosure, as a plurality of antenna arrays are positioned in diagonal relationship, the influence of a user's grip on communication performance may be reduced. For another example, an electronic device may improve the communication performance by selecting an antenna array, which is not affected by the user's grip, from among the plurality of antenna arrays by using a grip sensor and/or a posture control sensor. Besides, a variety of effects directly or indirectly understood through this disclosure may be provided.

Other aspects, advantages, and salient features of the disclosure will become apparent to those skilled in the art from the following detailed description, which, taken in conjunction with the annexed drawings, discloses various embodiments of the present disclosure.

### DESCRIPTION OF DRAWINGS

The above and other aspects, features, and advantages of certain embodiments of the present disclosure will be more apparent from the following description taken in conjunction with the accompanying drawings, in which:

FIG. 1 illustrates a block diagram of an electronic device in a network environment, according to various embodiments;

FIG. 2 illustrates a front view and a perspective view of an electronic device according to an embodiment;

FIG. 3 illustrates a block diagram of the electronic device according to an embodiment;

FIG. 4 is a view illustrating a communication module of an electronic device according to an embodiment;

FIG. 5 is a view for describing beamforming of an electronic device according to an embodiment;

FIG. 6 is a view for comparing antenna performance of an electronic device according to an embodiment;

FIG. 7 is a view for comparing antenna performance of an electronic device according to an embodiment;

FIG. 8A is a view for comparing antenna performance according to beam shifting of an electronic device according to an embodiment;

FIG. 8B is a view for comparing antenna performance according to beam shifting of an electronic device according to an embodiment;

FIG. 9 is a view illustrating antenna performance of an electronic device according to an embodiment in the case where two antenna arrays form beams in different directions;

FIG. 10A is a view illustrating an electronic device including a grip sensor and a posture detection sensor according to various embodiments;

FIG. 10B is a view illustrating an electronic device including a grip sensor and a posture detection sensor according to various embodiments;

FIG. 11 is a flowchart illustrating an operation in which an electronic device according to an embodiment forms a beam and transmits/receives data;

FIG. 12 is a view illustrating antenna arrangement of the electronic device according to various embodiments;

FIG. 13 is a flowchart illustrating an operation in which an electronic device transmits data, according to an embodiment; and

FIG. 14 is a flowchart illustrating an operation in which an electronic device receives data, according to an embodiment.

### MODE FOR INVENTION

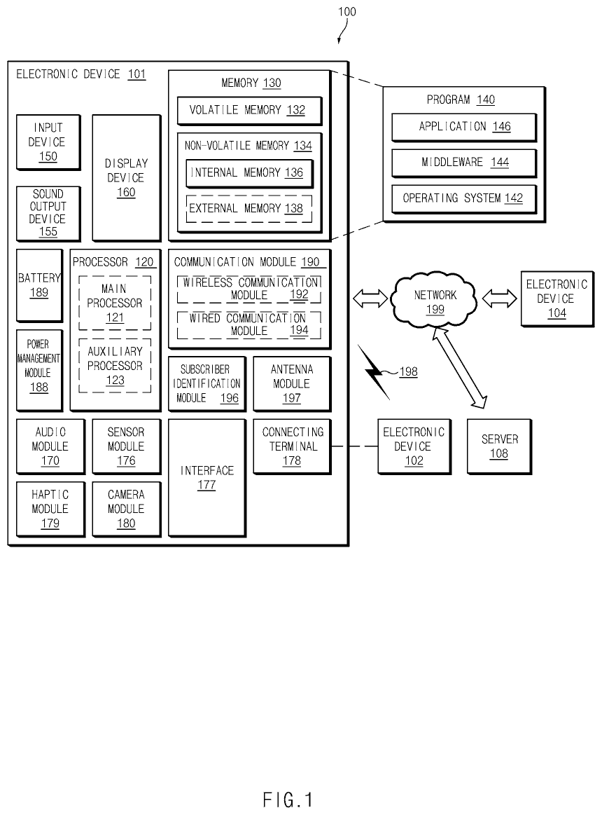

FIG. 1 is a block diagram of an electronic device in a network environment according to various embodiments.

Referring to FIG. 1, an electronic device 101 may communicate with an electronic device 102 through a first network 198 (e.g., a short-range wireless communication) or may communicate with an electronic device 104 or a server 108 through a second network 199 (e.g., a long-distance wireless communication) in a network environment 100. According to an embodiment, the electronic device 101 may communicate with the electronic device 104 through the server 108. According to an embodiment, the electronic device 101 may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module 196, and an antenna module 197. According to some embodiments, at least one (e.g., the display device 160 or the camera module 180) among components of the electronic device 101 may be omitted or other components may be added to the electronic device 101. According to some embodiments, some components may be integrated and implemented as in the case of the sensor module 176 (e.g., a fingerprint sensor, an iris sensor, or an illuminance sensor) embedded in the display device 160 (e.g., a display).

The processor 120 may operate, for example, software (e.g., a program 140) to control at least one of other components (e.g., a hardware or software component) of the electronic device 101 connected to the processor 120 and may process and compute a variety of data. The processor 120 may load a command set or data, which is received from other components (e.g., the sensor module 176 or the communication module 190), into a volatile memory 132, may process the loaded command or data, and may store result data into a nonvolatile memory 134. According to an embodiment, the processor 120 may include a main processor 121 (e.g., a central processing unit or an application processor) and an auxiliary processor 123 (e.g., a graphic processing device, an image signal processor, a sensor hub processor, or a communication processor), which operates independently from the main processor 121, additionally or alternatively uses less power than the main processor 121, or is specified to a designated function. In this case, the auxiliary processor 123 may operate separately from the main processor 121 or embedded.

In this case, the auxiliary processor 123 may control, for example, at least some of functions or states associated with at least one component (e.g., the display device 160, the sensor module 176, or the communication module 190) among the components of the electronic device 101 instead of the main processor 121 while the main processor 121 is in an inactive (e.g., sleep) state or together with the main processor 121 while the main processor 121 is in an active (e.g., an application execution) state. According to an embodiment, the auxiliary processor 123 (e.g., the image signal processor or the communication processor) may be implemented as a part of another component (e.g., the camera module 180 or the communication module 190) that is functionally related to the auxiliary processor 123. The memory 130 may store a variety of data used by at least one component (e.g., the processor 120 or the sensor module 176) of the electronic device 101, for example, software (e.g., the program 140) and input data or output data with respect to commands associated with the software. The memory 130 may include the volatile memory 132 or the nonvolatile memory 134.

The program 140 may be stored in the memory 130 as software and may include, for example, an operating system 142, a middleware 144, or an application 146.

The input device 150 may be a device for receiving a command or data, which is used for a component (e.g., the processor 120) of the electronic device 101, from an outside (e.g., a user) of the electronic device 101 and may include, for example, a microphone, a mouse, or a keyboard.

The sound output device 155 may be a device for outputting a sound signal to the outside of the electronic device 101 and may include, for example, a speaker used for general purposes, such as multimedia play or recordings play, and a receiver used only for receiving calls. According to an embodiment, the receiver and the speaker may be either integrally or separately implemented.

The display device 160 may be a device for visually presenting information to the user and may include, for example, a display, a hologram device, or a projector and a control circuit for controlling a corresponding device. According to an embodiment, the display device 160 may include a touch circuitry or a pressure sensor for measuring an intensity of pressure on the touch.

The audio module 170 may convert a sound and an electrical signal in dual directions. According to an embodiment, the audio module 170 may obtain the sound through the input device 150 or may output the sound through an external electronic device (e.g., the electronic device 102 (e.g., a speaker or a headphone)) wired or wirelessly connected to the sound output device 155 or the electronic device 101.

The sensor module 176 may generate an electrical signal or a data value corresponding to an operating state (e.g., power or temperature) inside or an environmental state outside the electronic device 101. The sensor module 176 may include, for example, a gesture sensor, a gyro sensor, a barometric pressure sensor, a magnetic sensor, an acceleration sensor, a grip sensor, a proximity sensor, a color sensor, an infrared sensor, a biometric sensor, a temperature sensor, a humidity sensor, or an illuminance sensor.

The interface 177 may support a designated protocol wired or wirelessly connected to the external electronic device (e.g., the electronic device 102). According to an embodiment, the interface 177 may include, for example, an HDMI (high-definition multimedia interface), a USB (universal serial bus) interface, an SD card interface, or an audio interface.

A connecting terminal 178 may include a connector that physically connects the electronic device 101 to the external electronic device (e.g., the electronic device 102), for example, an HDMI connector, a USB connector, an SD card connector, or an audio connector (e.g., a headphone connector).

The haptic module 179 may convert an electrical signal to a mechanical stimulation (e.g., vibration or movement) or an electrical stimulation perceived by the user through tactile or kinesthetic sensations. The haptic module 179 may include, for example, a motor, a piezoelectric element, or an electric stimulator.

The camera module 180 may shoot a still image or a video image. According to an embodiment, the camera module 180 may include, for example, at least one lens, an image sensor, an image signal processor, or a flash.

The power management module 188 may be a module for managing power supplied to the electronic device 101 and may serve as at least a part of a power management integrated circuit (PMIC).

The battery 189 may be a device for supplying power to at least one component of the electronic device 101 and may include, for example, a non-rechargeable (primary) battery, a rechargeable (secondary) battery, or a fuel cell.

The communication module 190 may establish a wired or wireless communication channel between the electronic device 101 and the external electronic device (e.g., the electronic device 102, the electronic device 104, or the server 108) and support communication execution through the established communication channel. The communication module 190 may include at least one communication processor operating independently from the processor 120 (e.g., the application processor) and supporting the wired communication or the wireless communication. According to an embodiment, the communication module 190 may include a wireless communication module 192 (e.g., a cellular communication module, a short-range wireless communication module, or a GNSS (global navigation satellite system) communication module) or a wired communication module 194 (e.g., an LAN (local area network) communication module or a power line communication module) and may communicate with the external electronic device using a corresponding communication module among them through the first network 198 (e.g., the short-range communication network such as a Bluetooth, a WiFi direct, or an IrDA (infrared data association)) or the second network 199 (e.g., the long-distance wireless communication network such as a cellular network, an internet, or a computer network (e.g., LAN or WAN)). The above-mentioned various communication modules 190 may be implemented into one chip or into separate chips, respectively.

According to an embodiment, the wireless communication module 192 may identify and authenticate the electronic device 101 using user information stored in the subscriber identification module 196 in the communication network.

The antenna module 197 may include one or more antennas to transmit or receive the signal or power to or from an external source. According to an embodiment, the communication module 190 (e.g., the wireless communication module 192) may transmit or receive the signal to or from the external electronic device through the antenna suitable for the communication method.

Some components among the components may be connected to each other through a communication method (e.g., a bus, a GPIO (general purpose input/output), an SPI (serial peripheral interface), or an MIPI (mobile industry processor interface)) used between peripheral devices to exchange signals (e.g., a command or data) with each other.

According to an embodiment, the command or data may be transmitted or received between the electronic device 101 and the external electronic device 104 through the server 108 connected to the second network 199. Each of the electronic devices 102 and 104 may be the same or different types as or from the electronic device 101. According to an embodiment, all or some of the operations performed by the electronic device 101 may be performed by another electronic device or a plurality of external electronic devices. When the electronic device 101 performs some functions or services automatically or by request, the electronic device 101 may request the external electronic device to perform at least some of the functions related to the functions or services, in addition to or instead of performing the functions or services by itself. The external electronic device receiving the request may carry out the requested function or the additional function and transmit the result to the electronic device 101. The electronic device 101 may provide the requested functions or services based on the received result as is or after additionally processing the received result. To this end, for example, a cloud computing, distributed computing, or client-server computing technology may be used.

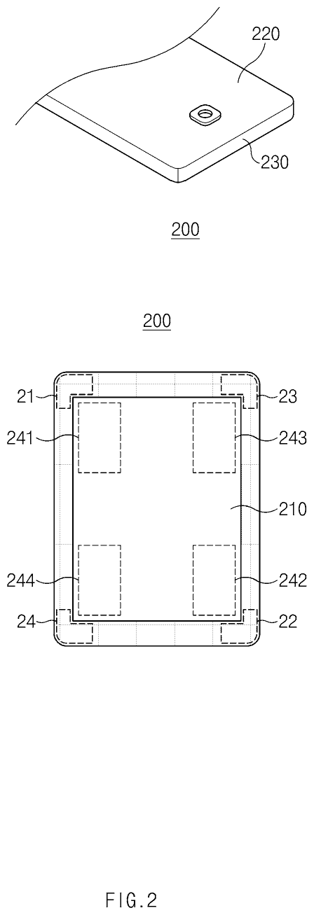

FIG. 2 illustrates a front view and a perspective view of an electronic device according to an embodiment.

Referring to FIG. 2, an electronic device 200 (e.g., the electronic device 101) according to an embodiment may be surrounded by a housing. The housing may include a cover glass 210 (e.g., a first plate), a rear plate 220 (e.g., a second plate) facing away from the cover glass 210, and a side member 230 surrounding a space between the cover glass 210 and the rear plate 220.

According to an embodiment, a shape of the cover glass 210 and the rear plate 220 may be a substantial quadrangle. The substantial quadrangle may be, for example, the concept including a rectangle, a rhombus, a rounded rectangle, or the like. In an embodiment, when viewed from above the cover glass 210, the housing may be a rectangular shape including a first corner 21, a second corner 22, a third corner 23, and a fourth corner 24.

According to an embodiment, the electronic device 200 may include at least one or more antenna arrays. For example, the electronic device 200 may include a first antenna array 241, a second antenna array 242, a third antenna array 243, and a fourth antenna array 244.

According to an embodiment, the antenna arrays 241, 242, 243, and 244 may include a plurality of antenna elements. For example, the first antenna array 241 may include a first plurality of antenna elements. The second antenna array 242 may include a second plurality of antenna elements. The third antenna array 243 may include a third plurality of antenna elements. The fourth antenna array 244 may include a fourth plurality of antenna elements. According to an embodiment, the plurality of elements may be arranged in a specified layout. For example, the first antenna array 241 may include 16 antenna elements, and the antenna elements may be arranged in a 4-by-4 matrix.

In an embodiment, the electronic device 200 may transmit/receive data by transmitting/receiving a radio frequency (RF) signal through an antenna array (e.g., the first antenna array 241). For example, the first antenna array 241 may transmit a first RF signal corresponding to first data or may receive the first RF signal from any other device. For another example, the second antenna array 242 may transmit/receive a second RF signal corresponding to the first data. The third antenna array 243 may transmit/receive a third RF signal corresponding to second data. The fourth antenna array 244 may transmit/receive a fourth RF signal corresponding to the second data.

According to an embodiment, the first antenna array 241 and the second antenna array 242 may transmit/receive the first data, and the third antenna array 243 and the fourth antenna array 244 may transmit/receive the second data. According to an embodiment, the first data and the second data may be different from each other in a specific condition. In this case, the first RF signal and the third RF signal may be different from each other, and the second RF signal and the fourth RF signal may be different from each other. The specific condition may correspond, for example, to the case where the electronic device 200 performs multi input multi output (MIMO) only by using the first antenna array 241 and the third antenna array 243 while a user grips a portion of the electronic device 200, which corresponds to the second antenna array 242 and the fourth antenna array 244.

According to an embodiment, the first data and the second data may be the same as each other in a specific condition. In this case, the first RF signal, the second RF signal, the third RF signal, and the fourth RF signal may be the same as each other. The specific condition may correspond, for example, to the case where the electronic device 200 performs beam forming on the first antenna array 241 and the third antenna array 243 while the user grips the portion of the electronic device 200, which corresponds to the second antenna array 242 and the fourth antenna array 244.

In an embodiment, the antenna arrays 241, 242, 243, and 244 may be positioned within the housing so as to be adjacent to the corners of the side member 230, respectively. For example, the first antenna array 241 may be positioned adjacent to the first corner 21 of the side member 230. For another example, the second antenna array 242 may be positioned adjacent to the second corner 22 of the side member 230. The third antenna array 243 may be positioned adjacent to the third corner 23 of the side member 230. The fourth antenna array 244 may be positioned adjacent to the fourth corner 24 of the side member 230.

According to an embodiment, the first corner 21 and the second corner 22 may be in diagonal relationship, and the third corner 23 and the fourth corner 24 may be in diagonal relationship. For example, the first antenna array 241 and the second antenna array 242 may be in diagonal relationship, and the third antenna array 243 and the fourth antenna array 244 may be in diagonal relationship.

According to an embodiment, the second corner 22 may be separated from the first corner 21 by a first gap. The third corner 23 may be separated from the first corner 21 by a second gap shorter than the first gap. The fourth corner 24 may be separated from the first corner 21 by a third gap which is shorter than the first gap and is longer than the second gap.

According to an embodiment, at least one of the first antenna array 241, the second antenna array 242, the third antenna array 243, and the fourth antenna array 244 may be configured to transmit/receive a signal in a frequency band including approximately 28 GHz. However, the signal in the frequency band is not limited to approximately 28 GHz. For example, the signal in the frequency band may be included in at least a portion of a range from approximately 10 GHz to approximately 80 GHz.

According to an embodiment, the electronic device 200 may be configured to transmit/receive at least one of the first RF signal, the second RF signal, the third RF signal, and the fourth RF signal in a time division duplex (TDD) manner.

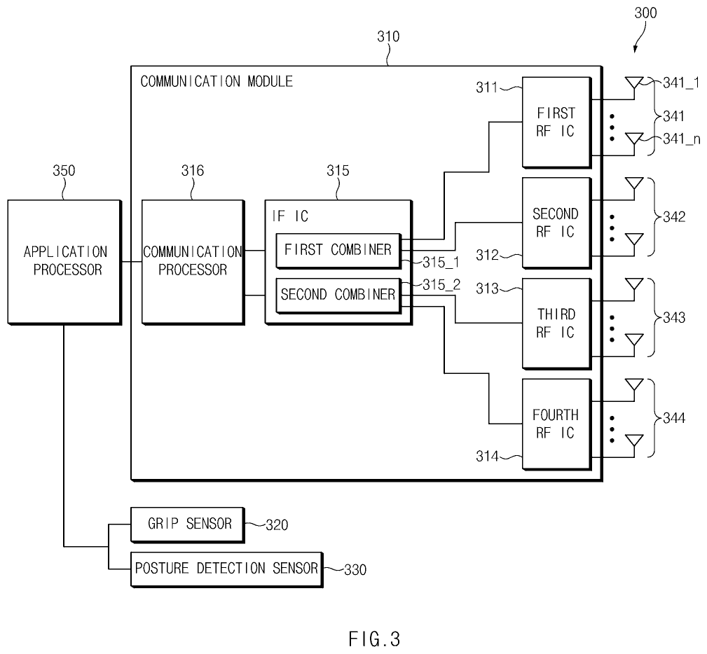

FIG. 3 illustrates a block diagram of the electronic device according to an embodiment.

Referring to FIG. 3, an electronic device 300 (e.g., the electronic device 101 of FIG. 1 or the electronic device 200 of FIG. 2) may include a communication module 310, a grip sensor 320, a posture detection sensor 330, a first antenna array 341, a second antenna array 342, a third antenna array 343, a fourth antenna array 344, and an application processor (AP) 350. In various embodiments, the electronic device 300 may further include a component not illustrated in FIG. 3 or may not include a part of the components of FIG. 3. For example, the electronic device 300 may not include the grip sensor 320 or the posture detection sensor 330. In FIG. 3, components which are the same as the components described with reference to FIG. 2 will not be described to avoid redundancy.

According to an embodiment, the antenna arrays 341, 342, 343, and 344 may include a plurality of antenna elements. For example, the first antenna array 341 may include “n” antenna elements (e.g., 341_1 to 341_n), wherein “n” is a natural number of 2 or more.

According to an embodiment, the communication module 310 may include a first RF IC 311, a second RF IC 312, a third RF IC 313, a fourth RF IC 314, an intermediate frequency (IF) IC 315, and a communication processor (CP) 316. According to an embodiment, the communication module 310 may be configured to provide beam forming by using at least one of the first antenna array 341, the second antenna array 342, the third antenna array 343, and the fourth antenna array 344. According to various embodiments, the communication module 310 may be referred to as a “wireless communication circuit”.

In an embodiment, the first RF IC 311, the second RF IC 312, the third RF IC 313, and the fourth RF IC 314 may be electrically connected with the first antenna array 341, the second antenna array 342, the third antenna array 343, and the fourth antenna array 344, respectively.

In an embodiment, an RF IC (e.g., the first RF IC 311) may process a RF signal which is transmitted or received at an antenna array (e.g., the first antenna array 341). For example, the first RF IC 311 may perform phase shift and amplitude amplification on the first RF signal received by the first antenna array 341, and may integrate RF signals received by antenna elements. For another example, the first RF IC 311 may perform phase shift and amplitude amplification on the first RF signal converted from a first IF signal provided by the IF IC 315. The first RF IC 311 may provide the first RF signal to an antenna element (e.g., 341_1 or 341_n) included in the first antenna array 341. For another example, the second RF IC 312 may process the second RF signal, the third RF IC 313 may process the third RF signal, and the fourth RF IC 314 may process the fourth RF signal.

According to an embodiment, the IF IC 315 may include a first combiner 315_1 and a second combiner 315_2. In an embodiment, when the electronic device 300 is in a signal receive mode, the first combiner 315_1 may integrate a signal processed by the first RF IC 311 and a signal processed by the second RF IC 312, and the second combiner 315_2 may integrate a signal processed by the third RF IC 313 and a signal processed by the fourth RF IC 314. In an embodiment, when the electronic device 300 operates in a signal transmit mode, the first combiner 315_1 may divide a first IF signal so as to be provided to the first RF IC 311 and the second RF IC 312. The second combiner 315_2 may divide a second IF signal so as to be provided to the third RF IC 313 and the fourth RF IC 314.

According to an embodiment, the IF IC 315 may process a first IF signal which corresponds to the first RF signal and the second RF signal and a second IF signal which corresponds to the third RF signal and the fourth RF signal. The IF signal (e.g., a first IF signal) may mean, for example, a signal which is downconverted to an intermediate frequency before an RF signal (e.g., a first RF signal) processed by an RF IC is converted to a signal of a base band to be processed by the communication processor 316.

According to an embodiment, the communication processor 316 may control overall operations of the communication module 310. For example, the communication processor 316 may control at least one of the first antenna array 341, the second antenna array 342, the third antenna array 343, and the fourth antenna array 344 such that at least one beam for transmitting/receiving at least one of the first RF signal, the second RF signal, the third RF signal, and the fourth RF signal is formed.

According to an embodiment, antenna elements included in the antenna arrays 341, 342, 343, and 344 may transmit/receive at least one of the first RF signal, the second RF signal, the third RF signal, and the fourth RF signal. The communication processor 316 may change a phase of the at least one RF signal which the antenna arrays 341, 342, 343, and 344 transmit/receive for the purpose of forming the at least one beam. For example, the communication processor 316 may change a phase of the first RF signal through a phase shifter which may be included in the first RF IC 311.

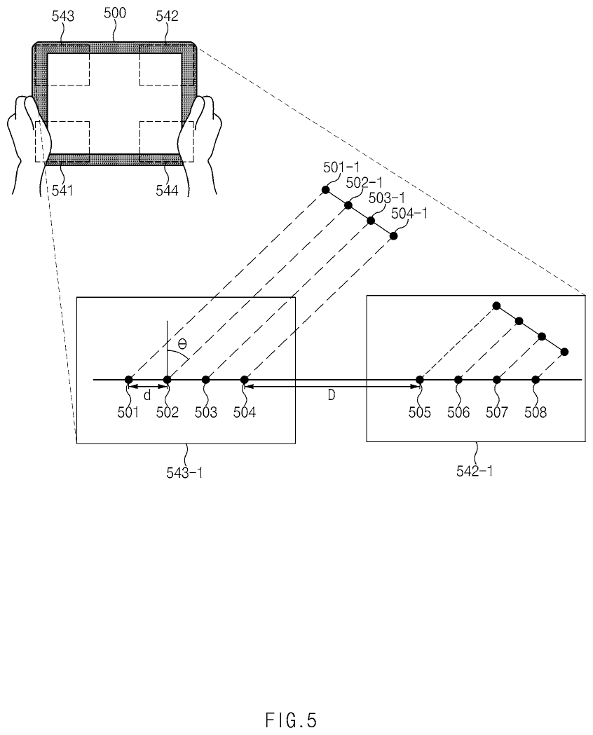

For example, the communication processor 316 may change the phase of the first RF signal which a plurality of antenna elements (e.g., 341_1 to 341_n) included in the first antenna array 341 transmit/receive. In the case where the phase of the first RF signal transmitted/received through the antenna elements satisfies a specified condition, the first antenna array 341 may form the at least one beam. The specified condition in which the beam may be formed will be described with reference to FIG. 5.

According to an embodiment, at least one grip sensor 320 may be positioned on a partial surface of the electronic device 300 or may be positioned adjacent to the partial surface. The electronic device 300 may detect whether a grip of the user is made, by using the at least one grip sensor 320. For example, two grip sensors 320 may be positioned on opposite sides, which face each other, of the electronic device 300, and may detect a grip of the user on the opposite sides of the electronic device 300 where the grip sensors 320 are positioned. According to various embodiments, a grip sensor may be referred to as a “sensor circuit”. The sensor circuit may include, for example, a capacitance-based sensor.

According to an embodiment, the at least one posture detection sensor 330 may sense a posture of the electronic device 300. For example, the posture detection sensor 330 may sense whether a portion of the electronic device 300 is inclined. The posture detection sensor 330 may include, for example, a gyro sensor, an acceleration sensor, or a geomagnetic sensor.

According to an embodiment, the application processor 350 may be electrically connected with components included in the electronic device 300 and may perform an arithmetic operation and/or data processing associated with control and/or communication of the component included in the electronic device 300.

According to an embodiment, in the case where the at least one grip sensor 320 senses a grip of the user, the application processor 350 may determine whether the grip of the user is sensed by the grip sensor 320 positioned at any location of the electronic device 300. The application processor 350 may provide the determination result to the communication processor 316.

According to an embodiment, the communication processor 316 may select an antenna array which will transmit/receive at least one of the first data and the second data, based on the detection result of the at least one grip sensor 320. For example, the application processor 350 may determine a location at which an electronic device is gripped, based on a sensing result of the at least one grip sensor 320. Depending on the determination result, the communication processor 316 may select an antenna array which will transmit/receive at least one of the first data and the second data.

For example, depending on the detection result of the grip sensor 320, the application processor 350 may determine that a region adjacent to a second corner of the electronic device 300 and a region adjacent to a fourth corner of the electronic device 300 are gripped. The application processor 350 may provide the determination result to the communication processor 316. For the purpose of transmitting/receiving at least one of the first data and the second data, the communication processor 316 may select at least one of the first antenna array 341 and the third antenna array 343 depending on the determination result. In the case where the region adjacent to the second corner and the region adjacent to the fourth corner are gripped, since performance of communication of the second antenna array 342 and the fourth antenna array 344 is limited, it may be advantageous to select the first antenna array 341 or the third antenna array 343 and to communicate through the selected array.

According to an embodiment, the grip sensor 320 may provide the detection result associated with the user's grip to the communication processor 316. For example, the communication processor 316 may directly receive the detection result from the grip sensor 320 and may select an antenna array which is not adjacent to a region where a grip of the user is made.

In an embodiment, in the case where the posture detection sensor 330 senses the posture of the electronic device 300, the application processor 350 may estimate any region where the user's grip is made. For example, in the case where the posture of the electronic device 300 is sensed as a second corner (e.g., the second corner 22 of FIG. 2) and a fourth corner (e.g., the fourth corner 24 of FIG. 2) are more adjacent to the ground than a first corner (e.g., the first corner 21 of FIG. 2) and a third corner (e.g., the third corner 23 of FIG. 2), the application processor 350 may estimate that the user grips a region adjacent to the second corner and a region adjacent to the fourth corner. The application processor 350 may provide the estimation result to the communication processor 316.

According to an embodiment, the communication processor 316 may select an antenna array which will transmit/receive at least one of the first data and the second data, based on the posture detection result of the posture detection sensor 330. For example, the application processor 350 may estimate a gripped location of an electronic device based on the detection result of the posture detection sensor 330, and may select an antenna array which will transmit/receive at least one of the first data and the second data, based on the estimation result.

For example, the application processor 350 may estimate that the user grips the region adjacent to the second corner and the region adjacent to the fourth corner and may provide the estimation result to the communication processor 316. In this case, for the purpose of transmitting/receiving at least one of the first data and the second data, the communication processor 316 may select at least one of the first antenna array 341 and the third antenna array 343 depending on the estimation result.

According to an embodiment, the posture detection sensor 330 may provide the communication processor 316 with a result of sensing a posture of an electronic device. For example, the communication processor 316 may directly receive the sensing result from the posture detection sensor 330 and may estimate a region where a grip of the user is made. The communication processor 316 may select an antenna array for transmitting/receiving at least one of the first data and the second data based on the estimation result.

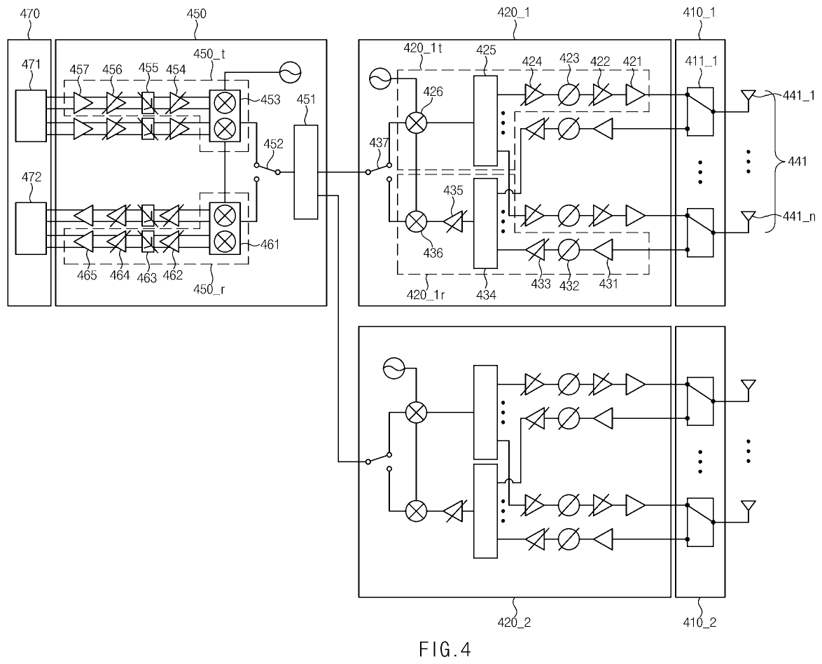

FIG. 4 is a view illustrating a communication module of an electronic device according to an embodiment.

Referring to FIG. 4, a communication module (e.g., the communication module 310 of FIG. 3) may include a first switch group 410_1, a second switch group 410_2, a first RF IC 420_1 (e.g., the first RF IC 311 of FIG. 3), a second RF IC 420_2 (e.g., the second RF IC 312 of FIG. 3), an IF IC 450, and a communication processor 470. In various embodiments, the communication module may further include one or more components not illustrated in FIG. 4 or may not include a part of components illustrated in FIG. 4. For example, the communication module may further include a third RF IC and a fourth RF IC as components. In FIG. 4, components which are the same as the components described with reference to FIG. 3 will not be described to avoid redundancy.

According to an embodiment, antenna elements (e.g., 441_1 to 441_n) included in a first antenna array 441 may be connected with the first RF IC 420_1 through a switch 411_1 included in the first switch group 410_1. For example, in the case where an electronic device (e.g., the electronic device 101 of FIG. 1) transmits an RF signal (e.g., in the case of a signal transmit mode), the switch 411_1 may connect an antenna element (e.g., 441_1) and a power amplifier (PA) (e.g., 421); in the case where the electronic device receives an RF signal (e.g., in the case of a signal receive mode), the switch 411_1 may connect the antenna element (e.g., 441_1) and a low noise amplifier (LNA) (e.g., 431).

According to an embodiment, the first RF IC 420_1 may include a transmit path 420_1t and a receive path 420_1r with regard to an RF signal.

According to an embodiment, in the case where the electronic device is in the signal transmit mode, the PA 421, a first variable gain amplifier (VGA) 422, a phase shifter (PS) 423, a second VGA 424, a combiner 425, and a mixer 426 may be positioned on the transmit path 420_1t of the RF signal.

The PA 421 may amplify a power of the RF signal. According to an embodiment, the PA 421 may be mounted inside or outside the first RF IC 420_1. The first VGA 422 and the second VGA 424 may perform a transmit auto gain control operation under control of the communication processor 470. According to an embodiment, the number of variable gain amplifiers may be not less than 2 or may be less than 2 The PS 423 may change a phase of the RF signal based on a beamforming angle under control of the communication processor 470. The combiner 425 may divide the RF signal from the mixer 426 into “n” signals. The number of the divided signals may be the same as the number of antenna elements (e.g., 441_1 to 441_n) included in the first antenna array 441. The mixer 426 may upconvert an IF signal from the IF IC 450 to the RF signal. In an embodiment, the mixer 426 may receive a signal to be mixed from an internal or external oscillator.

According to an embodiment, in the case where the electronic device is in the signal receive mode, the LNA 431, a PS 432, a first VGA 433, a combiner 434, a second VGA 435, and a mixer 436 may be positioned on the receive path 420_1r of the RF signal.

The LNA 431 may amplify an RF signal received from an antenna element (e.g., 441_1 or 441_n). The first VGA 433 and the second VGA 435 may perform a receive AGC operation under control of the communication processor 470. According to an embodiment, the number of variable gain amplifiers may be not less than 2 or may be less than 2 The PS 432 may change a phase of the RF signal based on a beamforming angle under control of the communication processor 470. The combiner 434 may combine RF signals aligned in phase through phase shift. The combined signal may be provided to the mixer 436 through the second VGA 435. The mixer 436 may downconvert the received RF signal to an IF signal. In an embodiment, the mixer 436 may receive a signal to be mixed from an internal or external oscillator.

According to an embodiment, a first RF IC may further include a switch 437 which electrically connects a mixer and an IF IC. The switch 437 may selectively connect the transmit path 420_1t or the receive path 420_1r of the RF signal with the IF IC 450.

According to an embodiment, a configuration of the second RF IC 420_2 may correspond to the configuration of the first RF IC 420_1.

According to an embodiment, the IF IC 450 may include a combiner 451, a transmit path 450_t, a receive path 450_r, and a switch 452 selectively connecting the transmit path 450_t or the receive path 450_r with the combiner 451.

According to an embodiment, when an electronic device is in a signal receive mode, the combiner 451 may integrate the signal processed by the first RF IC 420_1 and the signal processed by the second RF IC 420_2. When an electronic device is in a signal transmit mode, the combiner 451 may divide an IF signal so as to be provided to the first RF IC 420_1 and the second RF IC 420_2. In an embodiment, the combiner 451 may be implemented with at least one or more combiners.

According to an embodiment, a mixer 453, a third VGA 454, a low pass filter (LPF) 455, a fourth VGA 456, and a buffer 457 may be positioned on the transmit path 450_t of the IF IC 450. The mixer 453 may convert a Balanced in-phase/quadrature-phase (I/Q) signal of a base band to an IF signal. The LPF 455 may serve as a channel filter with a bandwidth of a baseband signal as a cutoff frequency. In an embodiment, the cutoff frequency may be variable. The first VGA 454 and the second VGA 456 may perform the transmit AGC operation under control of the communication processor 470. According to an embodiment, the number of variable gain amplifiers may be not less than 2 or may be less than 2. The buffer 457 may function as buffering upon receiving the Balanced I/Q signal from the communication processor 470, and thus, the IF IC 450 may stably process the Balanced I/Q signal.

According to an embodiment, a mixer 461, a third VGA 462, an LPF 463, a fourth VGA 464, and a buffer 465 may be positioned on the receive path 450_r of the IF IC 450. The functions of the third VGA 462, the LPF 463, and the fourth VGA 464 may be the same as or similar to the functions of the third VGA 454, the LPF 455, and the fourth VGA 456 positioned on the transmit path 450_5. The mixer 461 may convert the IF signal from the first RF IC 420_1 and/or the second RF IC 420_2 to the Balanced I/Q signal of the base band. The buffer 465 may function as buffering upon providing the Balanced I/Q signal passing through the fourth VGA 464 to the communication processor 470, and thus, the IF IC 450 may stably process the Balanced I/Q signal.

According to an embodiment, the communication processor 470 may include a Tx I/Q digital analog converter (DAC) 471 and a Rx I/Q analog digital converter (ADC) 472. In an embodiment, the Tx I/Q DAC 471 may convert a digital signal modulated by a modem to the Balanced I/Q signal and may provide the Balanced I/Q signal to the IF IC 450. In an embodiment, the Rx I/Q ADC 472 may convert the Balanced I/Q signal which is converted by the IF IC 450 and may provide the digital signal to the modem. According to various embodiments, the communication processor 470 may perform multi input multi output (MIMO) or diversity. According to various embodiments, the communication processor 470 may be implemented with a separate chip or may be implemented in one chip together with any other component (e.g., the IF IC 450).

According to various embodiments, the communication module may further include an RF IC and an IF IC. For example, the communication module may further include a third RF IC, a fourth RF IC, and a second IF IC so as to be the same as or similar to the communication module 310 of FIG. 3. In an embodiment, the IF IC 450 and the second IF IC may be implemented with one chip.

FIG. 5 is a view for describing beamforming of an electronic device according to an embodiment.

Referring to FIG. 5, an electronic device 500 (e.g., the electronic device 101 of FIG. 1) may include a first antenna array 541, a second antenna array 542, a third antenna array 543, and a fourth antenna array 544. A third antenna array 543-1 corresponds to an enlarged view of the third antenna array 543, and a second antenna array 542-1 corresponds to an enlarged view of the second antenna array 542. In an embodiment, the third antenna array 543 may include a plurality of antenna elements (e.g., 501, 502, 503, and 504), and the second antenna array 542 may include a plurality of antenna elements (e.g., 505, 506, 507, and 508).

According to various embodiments, in FIG. 5, a region where the third antenna array 543 is positioned may be referred to as a “first region”, and a region where the second antenna array 542 is positioned may be referred to as a “second region”. According to various embodiments, a gap between the first antenna element 501 and the second antenna element 502 immediately adjacent to the first antenna element 501 may be referred to as a “first gap”. According to various embodiments, a gap between the third antenna array 543 and the second antenna array 542, for example, a gap between the fourth antenna element 504 and the fifth antenna element 505 may be referred to as a “second gap”.

According to an embodiment, the first antenna element 501, the second antenna element 502, the third antenna element 503, and the fourth antenna element 504 included in the third antenna array 543 may form a beam under a specified condition. For example, the specified condition may be satisfied when RF signals transmitted/received through the neighboring antenna elements (e.g., 501 and 502) have a phase difference of “0”. In this case, “0” represents a direction angle of a main lobe to be formed, and “d” represents a gap between neighboring antenna elements (e.g., 501 and 502). “f” represents a frequency of an RF signal to be transmitted/received, and “c” represents the speed of light. In the case where the specified condition is specified, RF signals may be in phase at respective points (e.g., 501-1, 502-1, 503-1, and 504-1) separated from an antenna array by a specific gap in a direction in which the beam is formed.

In an embodiment, according to the relational expression, a communication processor (e.g., the communication processor 316 of FIG. 3) may change a phase of at least one RF signal of a first RF signal, a second RF signal, a third RF signal, and a fourth RF signal in proportion to the gap “d” between the antenna elements. For example, the communication processor may change a phase of the third RF signal to be supplied to the third antenna array 543/543-1 in proportion to the gap “d” between the antenna elements. As a result, a first RF phase shift signal may be supplied to the first antenna element 501, a second RF phase shift signal to the second antenna element 502, a third RF phase shift signal to the third antenna element 503, and a fourth RF phase shift signal to the fourth antenna element 504.

In another embodiment, according to the relational expression, the communication processor may change a phase of at least one RF signal of the first RF signal, the second RF signal, the third RF signal, and the fourth RF signal in proportion to a sine value of a direction angle “0” of a main lobe to be formed.

According to an embodiment, the electronic device 500 may be configured to transmit/receive a plurality of RF signals (e.g., the first RF signal and the third RF signal) of the first RF signal, the second RF signal, the third RF signal, and the fourth RF signal at the same time. For example, the electronic device 500 may be configured to communicate by using the second antenna array 542 and the third antenna array 543 at the same time. In an embodiment, the communication processor may allow a plurality of beams to be formed at the same time, for the purpose of communicating by using the plurality of antenna arrays at the same time.

According to an embodiment, the communication processor may control the first antenna array 541, the second antenna array 542, the third antenna array 543, and the fourth antenna array 544 such that a plurality of beams for transmitting/receiving the plurality of RF signals at the same time are formed in the same direction. For example, the communication processor may control the second antenna array 542 and the third antenna array 543 such that directions of beams formed by the second antenna array 542 and the third antenna array 543 are the same as each other.

For example, the communication processor may allow a phase difference of (2πfD sin 0)/c to be formed between the fourth RF phase shift signal to be transmitted/received through the fourth antenna element 504 of the third antenna array 543 and a fifth RF phase shift signal to be transmitted/received through the fifth antenna element 505 of the second antenna array 542. In this case, “D” represents a gap between the fourth antenna element 504 and the fifth antenna element 505.

According to an embodiment, when the electronic device 500 is in the signal receive mode, the communication processor may control the first antenna array 541, the second antenna array 542, the third antenna array 543, and the fourth antenna array 544 such that a plurality of beams for receiving the plurality of RF signals at the same time are formed in different directions. For example, the communication processor may control the second antenna array 542 and the third antenna array 543 such that directions of beams formed by the second antenna array 542 and the third antenna array 543 are different from each other.

According to an embodiment, when the electronic device 500 is in the signal transmit mode, in the case where the plurality of beams are formed in different directions, a main lobe of the other party may be affected by a side lobe formed at each beam. In this case, the communication processor may determine whether to need to allow the plurality of beams to be formed in different directions, based on an electric field situation. The electric field situation may be determined, for example, based on at least one of a reference signals received power (RSRP), a reference signal received quality (RSRQ), a received signal strength index (RSSI), and a signal noise ratio (SNR).

According to an embodiment, in the case where the electric field situation is not smaller than a specified reference (e.g., is good), the communication processor may control the first antenna array 541, the second antenna array 542, the third antenna array 543, and the fourth antenna array 544 such that a plurality of beams for transmitting the plurality of RF signals at the same time are formed in different directions. In the case where the electric field situation is good, even though a main lobe of a beam formed at an antenna is affected by a side lobe of another beam, the absolute performance of the antenna may be good. In the case where the plurality of beams are formed in different directions, the electronic device 500 may be advantageous in terms of communication efficiency.

According to an embodiment, in the case where the electric field situation is smaller than the specified reference (e.g., is bad), the communication processor may control the first antenna array 541, the second antenna array 542, the third antenna array 543, and the fourth antenna array 544 such that a plurality of beams for transmitting the plurality of RF signals at the same time are formed in the same direction. In the case where the electric field situation is bad, when a main lobe of a beam formed at an antenna is affected by a side lobe of another beam, the absolute performance of the antenna may be reduced. In this case, it may be advantageous to form the plurality of beams in the same direction.

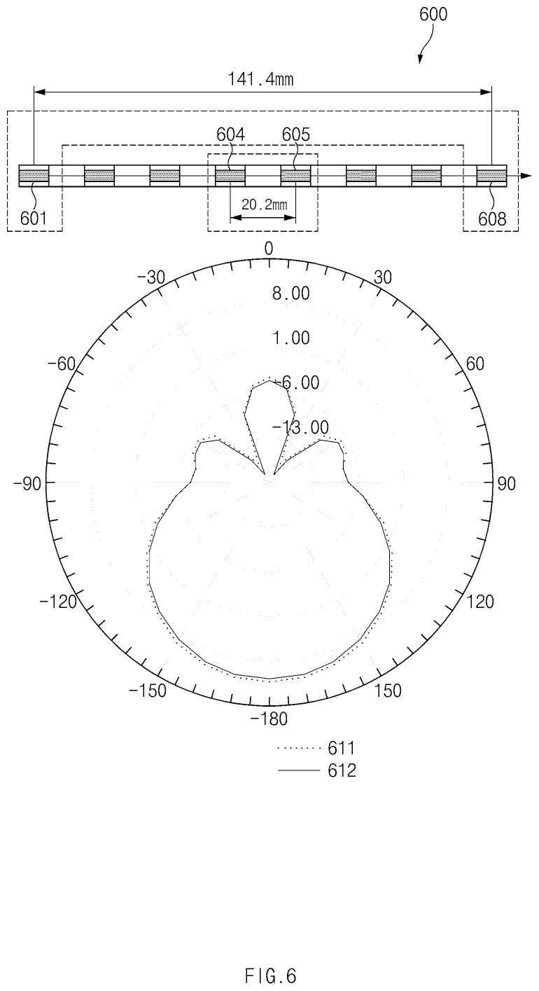

FIG. 6 is a view for comparing antenna performance of an electronic device according to an embodiment.

Referring to FIG. 6, a radiation pattern 611 when beamforming is made by using two antenna elements 601 and 608, the gap of which is relatively great, of an antenna array of an electronic device 600 and a radiation pattern 612 when beamforming is made by using two antenna elements 604 and 605, the gap of which is relatively small, of the antenna array of the electronic device 600 are illustrated.

It may be understood that a radiation shape of an antenna and an antenna gain are almost irrelevant to a gap between antenna elements participating in the beamforming. The following Table 1 shows an experimental value of the antenna gain. Even though a difference of gaps between antenna elements is approximately seven times, a difference of antenna gains may be only approximately 0.4 dB.

TABLE 1

| Distance (mm) | 141.4 | 20.2 |
|---|---|---|
| Antenna gain (dB) | 11.46438 | 11.01988 |

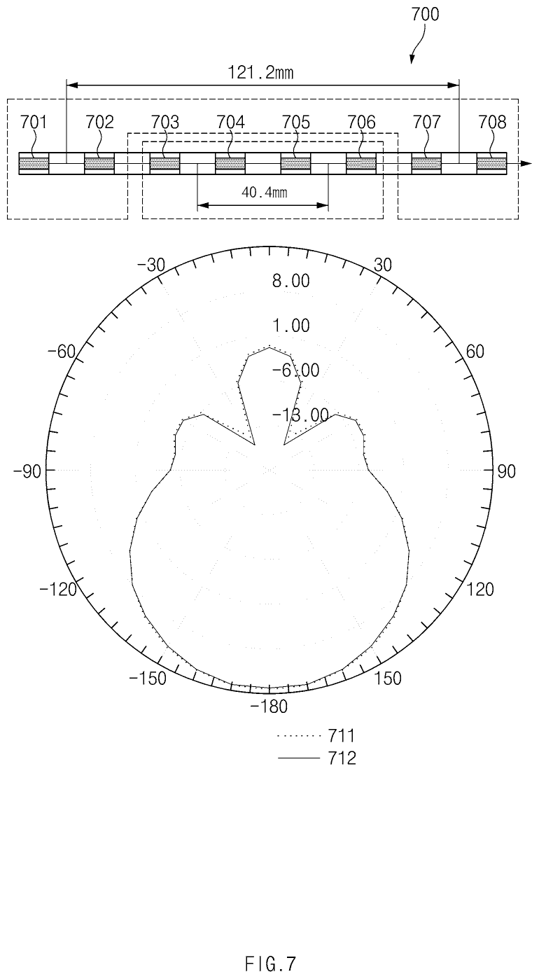

FIG. 7 is a view for comparing antenna performance of an electronic device according to an embodiment.

Referring to FIG. 7, a radiation pattern 711 when beamforming is made by using four antenna elements 701, 702, 707, and 708, the gap of which is relatively great, of an antenna array of an electronic device 700 and a radiation pattern 712 when beamforming is made by using four antenna elements 703, 704, 705, and 706, the gap of which is relatively small, of the antenna array of the electronic device 700 are illustrated.

It may be understood that a radiation shape of an antenna and an antenna gain are almost irrelevant to a gap between antenna elements participating in the beamforming. The following Table 2 shows an experimental value of the antenna gain. Even though a difference of gaps between antenna elements is approximately three times, a difference of antenna gains may be only approximately 0.2 dB.

TABLE 2

| Distance (mm) | 121.2 | 40.4 |
|---|---|---|
| Antenna gain (dB) | 14.23196 | 14.03429 |

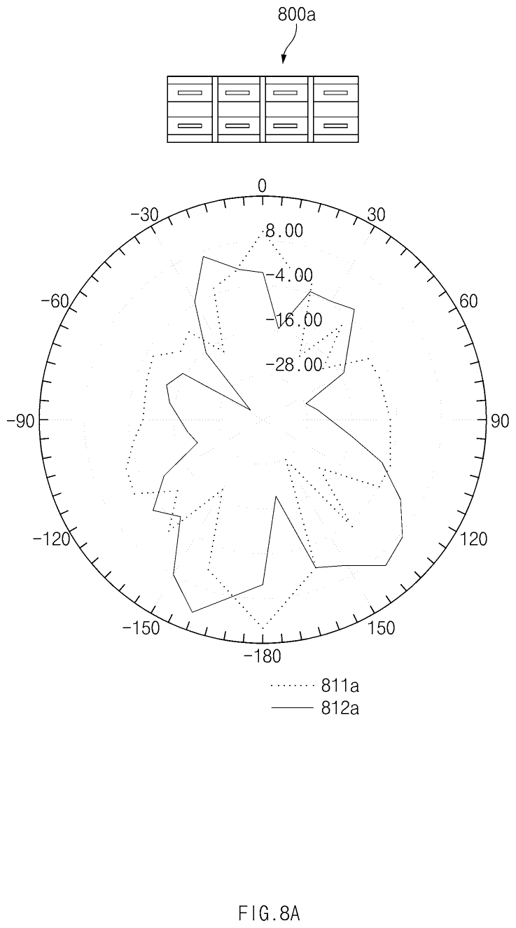

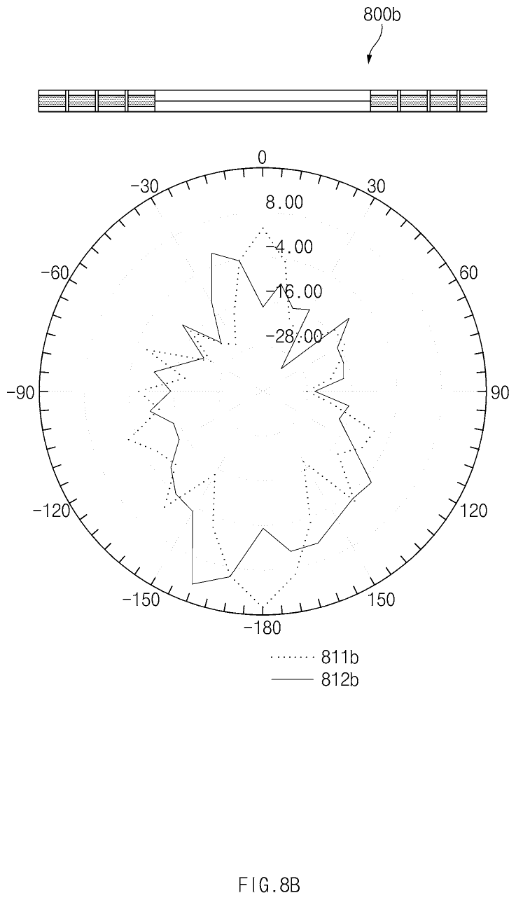

FIG. 8A is a view for comparing antenna performance according to beam shifting of an electronic device according to an embodiment.

Referring to FIG. 8A, in an antenna array 800a of an electronic device, a radiation pattern 811a when a direction angle of a main lobe of a beam is 0 degree and a radiation pattern 812a when the direction angle of the main lobe of the beam is 30 degrees are illustrated.

The antenna array 800a is composed of eight antenna elements, and the eight antenna elements are arranged in two layers each including four antenna elements. The following Table 3 shows an experimental value of the antenna gain. Compared with an antenna gain when a direction angle of a main lobe is 0 degree, an antenna gain when a direction angle of a main lobe is 30 degrees may be reduced by approximately 1 dB.

TABLE 3

| Direction angle (°) of main lobe | 0 | 30 |
|---|---|---|
| Antenna gain (dB) | 15.9392 | 14.9165 |

FIG. 8B is a view for comparing antenna performance according to beam shifting of an electronic device according to an embodiment.

Referring to FIG. 8B, in an antenna array 800b of an electronic device, a radiation pattern 811b when a direction angle of a main lobe of a beam is 0 degree and a radiation pattern 812b when the direction angle of the main lobe of the beam is 30 degrees are illustrated.

Two isolated antenna arrays participated in beamforming, and each antenna array was composed of four antenna elements. The antenna arrays were arranged in one layer in which eight antenna elements are placed. The following Table 4 shows an experimental value of the antenna gain. Compared with an antenna gain when a direction angle of a main lobe is 0 degree, an antenna gain when a direction angle of a main lobe is 30 degrees may be reduced by approximately 3.2 dB.

TABLE 4

| Direction angle (°) of main lobe | 0 | 30 |
|---|---|---|
| Antenna gain (dB) | 18.3018 | 15.1328 |

It is observed from Table 3 and Table 4 that a change in an antenna gain due to a change in a direction angle of a main lobe in the case of Table 3 is smaller than in the case of Table 4. In contrast, in comparison with only an absolute value of an antenna gain, it is observed from Table 3 and Table 4 that an antenna gain in the case of Table 4 is greater than in the case of Table 3 regardless of a change in a direction angle of a main lobe.

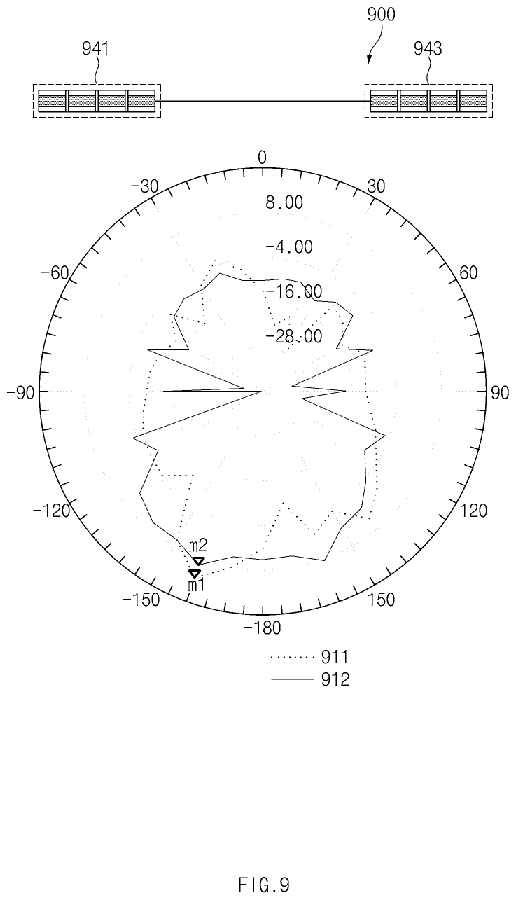

FIG. 9 is a view illustrating antenna performance of an electronic device according to an embodiment in the case where two antenna arrays form beams in different directions.

Referring to FIG. 9, a radiation pattern 911 when an electronic device 900 forms a beam by using a single antenna array 941 and a radiation pattern 912 when the electronic device 900 forms beams in different directions by using two antenna arrays 941 and 943.

The following Table 5 shows an experimental value of the antenna gain. In an embodiment, a beam was formed by using the single antenna array 941 such that a direction angle of a main lobe is 30 degrees, and an antenna gain at a maximum antenna gain point m1 was approximately 13.3 dB. In another embodiment, a beam was formed by using the two antenna arrays 941 and 943 such that direction angles of main lobes are 30 degrees and −30 degrees, respectively, and an antenna gain at a maximum antenna gain point m2 was approximately 9.7 dB. As observed from the following Table 5, in the case where beams are formed in different directions, a side lobe of any one beam has an influence on a main lobe of any other beam, and an antenna gain decreases by approximately 3.6 dB compared to the case of forming a beam by using a single antenna array.

TABLE 5

| Classification | m1 | m2 |
|---|---|---|
| Antenna gain (dB) | 13.3018 | 9.7016 |

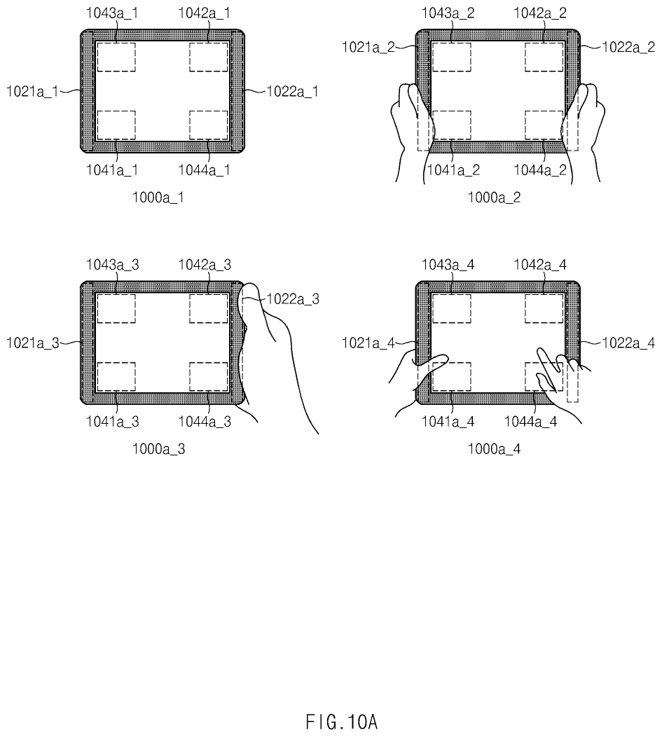

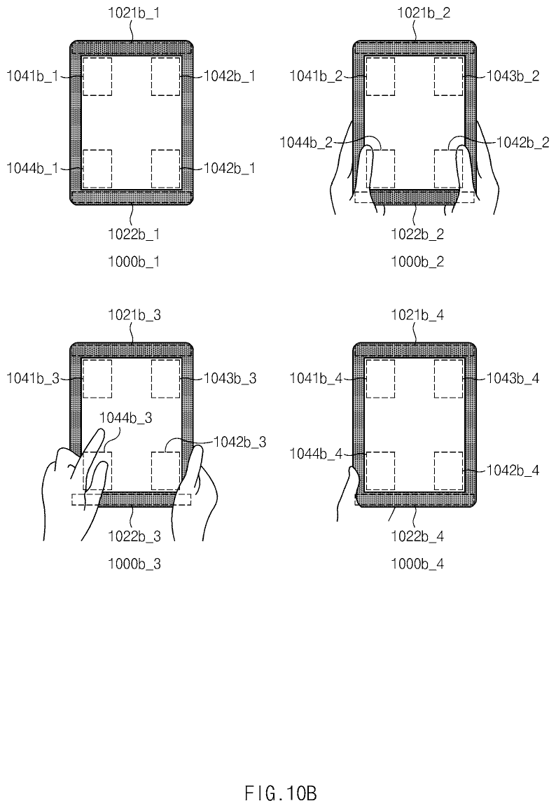

FIG. 10A is a view illustrating an electronic device including a grip sensor and a posture detection sensor according to various embodiments.

Referring to FIG. 10A, each electronic device (e.g., 1000a_1) may include antenna arrays (e.g., 1041a_1, 1042a_2, 1043a_3, and 1044a_4), grip sensors (e.g., 1021a_1 and 1022a_1), and a posture control sensor (e.g., 330 of FIG. 3).

In describing FIG. 10A, each electronic device 1000a_1, 1000a_2, 1000a_3, or 1000a_4 may have four corners. A corner adjacent to a first antenna array 1041a_1, 1041a_2, 1041a_3, or 1041a_4 may be referred to as “first corner”, a corner adjacent to a second antenna array 1042a_1, 1042a_2, 1042a_3, or 1042a_4 may be referred to as “second corner”, a corner adjacent to a third antenna array 1043a_1, 1043a_2, 1043a_3, or 1043a_4 may be referred to as “third corner”, and a corner adjacent to a fourth antenna array 1044a_1, 1044a_2, 1044a_3, and 1044a_4 may be referred to as “fourth corner”.

According to an embodiment, a communication processor included in an electronic device (e.g., 1000a_1) may select an antenna array (e.g., 1041a_1) which will transmit/receive at least one of first data and second data, based on a detection result of grip sensors (e.g., 1021a_1 and 1022a_1) and/or the posture detection sensor.

According to an embodiment, in the electronic device 1000a_1, the user may not grip the electronic device 1000a_1, and a posture of the electronic device 1000a_1 may be a posture in which the first corner and the fourth corner are closer to the ground than the second corner and the third corner. For example, an electronic device may be stood in a landscape mode.

In this case, the grip sensors 1021a_1 and 1022a_1 may not detect a grip of the user, and the posture detection sensor may detect that a region adjacent to the first corner and a region adjacent to the fourth corner are a region closer to the ground, and may provide the detection result to an application processor. The application processor may determine that no portion of the electronic device 1000a_1 is gripped, based on the detection result of the grip sensors 1021a_1 and 1022a_1 and the posture detection sensor, and may provide the determination result to the communication processor.

According to an embodiment, since no portion of the electronic device 1000a_1 is gripped, the communication processor may select all of the first antenna array 1041a_1, the second antenna array 1042a_1, the third antenna array 1043a_1, and the fourth antenna array 1043a_1 for the purpose of transmitting/receiving at least one of the first data and the second data.

According to another embodiment, in the electronic device 1000a_2, the user may grip lower portions of opposite sides of the electronic device 1000a_2, and a posture of the electronic device 1000a_2 may be a posture in which the first corner and the fourth corner are closer to the ground than the second corner and the third corner.

In this case, a first grip sensor 1021a_2 and a second grip sensor 1022a_2 may detect a grip of the user. The posture detection sensor may detect that the region adjacent to the first corner and the region adjacent to the fourth corner are a region closer to the ground. The detection result may be provided to the application processor.

The application processor may determine that the region adjacent to the first corner and the region adjacent to the fourth corner are gripped, from the detection results of the first grip sensor 1021a_2, the second grip sensor 1022a_2, and the posture detection sensor, and may provide the determination result to the communication processor.

Since the region adjacent to the first corner of the electronic device 1000a_2 and the region adjacent to the fourth corner of the electronic device 1000a_2 are gripped, the communication processor may select the second antenna array 1042a_2 and the third antenna array 1043a_2 for the purpose of transmitting/receiving at least one of the first data and the second data.

According to another embodiment, in the electronic device 1000a_3, the user may grip a right side of the electronic device 1000a_3, and a posture of the electronic device 1000a_3 may be a posture in which the first corner and the fourth corner are closer to the ground than the second corner and the third corner.

In this case, a first grip sensor 1021a_3 may detect that a grip of the user is not made. A second grip sensor 1022a_3 may detect that a grip of the user is made. The posture detection sensor may detect that the region adjacent to the first corner and the region adjacent to the fourth corner are a region closer to the ground. The detection result may be provided to the application processor.

The application processor may determine that a region adjacent to the second corner and a region adjacent to the fourth corner are gripped, from the detection results of the first grip sensor 1021a_3, the second grip sensor 1022a_3, and the posture detection sensor, and may provide the determination result to the communication processor.

Since the region adjacent to the second corner of the electronic device 1000a_3 and the region adjacent to the fourth corner of the electronic device 1000a_3 are gripped, the communication processor may select the first antenna array 1041a_3 and the third antenna array 1043a_3 for the purpose of transmitting/receiving at least one of the first data and the second data.

According to another embodiment, in the electronic device 1000a_4, the user may grip a left side of the electronic device 1000a_4, and a posture of the electronic device 1000a_4 may be a posture in which the first corner and the fourth corner are closer to the ground than the second corner and the third corner.

In this case, a first grip sensor 1021a_4 may detect that a grip of the user is made. A second grip sensor 1022a_4 may detect that a grip of the user is not made. The posture detection sensor may detect that the region adjacent to the first corner and the region adjacent to the fourth corner are a region closer to the ground. The detection result may be provided to the application processor.

The application processor may determine that a region adjacent to the first corner and a region adjacent to the third corner are gripped, from the detection results of the first grip sensor 1021a_4, the second grip sensor 1022a_4, and the posture detection sensor, and may provide the determination result to the communication processor.

Since the region adjacent to the first corner of the electronic device 1000a_4 and the region adjacent to the third corner of the electronic device 1000a_4 are gripped, the communication processor may select the second antenna array 1042a_4 and the fourth antenna array 1044a_4 for the purpose of transmitting/receiving at least one of the first data and the second data.

FIG. 10B is a view illustrating an electronic device including a grip sensor and a posture detection sensor according to various embodiments.

Referring to FIG. 10B, each electronic device 1000b_1, 1000b_2, 1000b_3, or 1000b_4 may correspond to each electronic device 1000a_1, 1000a_2, 1000a_3, or 1000a_4 illustrated in FIG. 10A.

According to an embodiment, in the electronic device 1000b_1, the user may not grip the electronic device 1000b_1, and a posture of the electronic device 1000b_1 may be a posture in which the second corner and the fourth corner are closer to the ground than the first corner and the third corner. For example, the electronic device 1000b_1 may be stood in a portrait mode.

In this case, grip sensors 1021b_1 and 1022b_1 may not detect a grip of the user, and the posture detection sensor may detect that a region adjacent to the second corner and a region adjacent to the fourth corner are a region closer to the ground, and may provide the detection result to an application processor of the electronic device 1000b_1.

The application processor may determine that no portion of the electronic device 1000b_1 is gripped, based on the detection result of the grip sensors 1021b_1 and 1022b_1 and the posture detection sensor, and may provide the determination result to the communication processor.

According to an embodiment, since no portion of the electronic device 1000b_1 is gripped, the communication processor may select all of a first antenna array 1041b_1, a second antenna array 1042b_1, a third antenna array 1043b_1, and a fourth antenna array 1044b_1 for the purpose of transmitting/receiving at least one of the first data and the second data.

According to another embodiment, in the electronic device 1000b_2, the user may grip lower portions of opposite sides of the electronic device 1000b_2, and a posture of the electronic device 1000b_2 may be a posture in which the second corner and the fourth corner are closer to the ground than the first corner and the third corner.

In this case, a first grip sensor 1021b_2 may detect that a grip of the user is not made. A second grip sensor 1022b_2 may detect that a grip of the user is made. The posture detection sensor may detect that the region adjacent to the second corner and the region adjacent to the fourth corner are a region closer to the ground. The detection result may be provided to the application processor.

The application processor may determine that a region adjacent to the second corner and a region adjacent to the fourth corner are gripped, from the detection results of the first grip sensor 1021b_2, the second grip sensor 1022b_2, and the posture detection sensor, and may provide the determination result to the communication processor.

Since the region adjacent to the second corner of the electronic device 1000b_2 and the region adjacent to the fourth corner of the electronic device 1000b_2 are gripped, the communication processor may select the first antenna array 1041b_2 and the third antenna array 1043b_2 for the purpose of transmitting/receiving at least one of the first data and the second data.

According to another embodiment, in the electronic device 1000b_3, the user may grip a lower portion of a right side of the electronic device 1000b_3, and a posture of the electronic device 1000b_3 may be a posture in which the second corner and the fourth corner are closer to the ground than the first corner and the third corner.

In this case, a first grip sensor 1021b_3 may detect that a grip of the user is not made. A second grip sensor 1022b_3 may detect that a grip of the user is made. The posture detection sensor may detect that the region adjacent to the second corner and the region adjacent to the fourth corner are a region closer to the ground. The detection result may be provided to the application processor.

The application processor may determine that a region adjacent to the second corner is gripped, from the detection results of the first grip sensor 1021b_3, the second grip sensor 1022b_3, and the posture detection sensor, and may provide the determination result to the communication processor.

Since the region adjacent to the second corner of the electronic device 1000b_3 is gripped, the communication processor may select the first antenna array 1041b_3, the third antenna array 1043b_3, and the fourth antenna array 1044b_3 for the purpose of transmitting/receiving at least one of the first data and the second data.

According to another embodiment, in the electronic device 1000b_4, the user may grip a lower portion of a left side of the electronic device 1000b_4, and a posture of the electronic device 1000b_4 may be a posture in which the second corner and the fourth corner are closer to the ground than the first corner and the third corner.

In this case, a first grip sensor 1021b_4 may detect that a grip of the user is not made. The second grip sensor 1022b_4 may detect that a grip of the user is made. The posture detection sensor may detect that the region adjacent to the second corner and the region adjacent to the fourth corner are a region closer to the ground. The detection result may be provided to the application processor.

The application processor may determine that a region adjacent to the fourth corner is gripped, from the detection results of the first grip sensor 1021b_4, the second grip sensor 1022b_4, and the posture detection sensor, and may provide the determination result to the communication processor.

Since the region adjacent to the fourth corner of the electronic device 1000b_4 is gripped, the communication processor may select the first antenna array 1041b_4, the second antenna array 1042b_4, and the third antenna array 1043b_4 for the purpose of transmitting/receiving at least one of the first data and the second data.

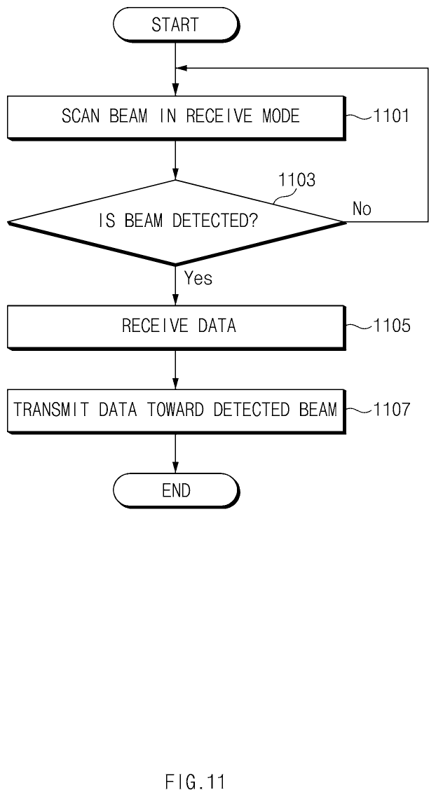

FIG. 11 is a flowchart illustrating an operation in which an electronic device according to an embodiment forms a beam and transmits/receives data.

Referring to FIG. 11, an operation in which an electronic device according to an embodiment forms a beam may include operation 1101 to operation 1107. Operation 1101 to operation 1107 may be performed by, for example, the electronic device 101 illustrated in FIG. 1.

In operation 1101, the electronic device may operate in a receive mode. Antenna array (e.g., the first antenna array 241 to the fourth antenna array 244 of FIG. 2) included in the electronic device may scan a beam for the purpose of receiving data. In this case, the antenna arrays may scan a beam in different directions. According to an embodiment, antenna arrays which receive the same data (e.g., first data) may scan a beam in the same direction for the purpose of preventing the attenuation of the received signal. For example, a first antenna array and a second antenna array may scan a beam in the same direction, and a third antenna array and a fourth antenna array may scan a beam in the same direction.

According to an embodiment, antenna arrays which receive different data may scan beams in different directions. For example, the first antenna array may receive the first data, and the third antenna array may receive the second data. In this case, the received first data may be processed through a first combiner, and the received second data may be processed through a second combiner. Since the first data and the second data are provided to a communication processor through different combiners, the first antenna array and the third antenna array may scan beams in different directions.

In operation 1103, the electronic device may determine whether a beam for receiving data is detected. In the case where the beam is not detected, the electronic device may repeatedly perform operation 1101. In the case where the beam is detected, the electronic device may perform operation 1105.

In operation 1105, the electronic device may receive data through the detected beam. The data may be a communication control signal defined in the communication standard. In an embodiment, the electronic device may control the antenna arrays such that the antenna arrays form a beam in the same direction as the detected beam. In an embodiment, the electronic device may allow a part of the antenna arrays to form a beam in a direction different from the direction of the detected beam and to scan a beam. According to an embodiment, the electronic device may support a receive diversity by receiving a signal by using different antenna arrays at the same time.

In operation 1107, the electronic device may transmit data in the direction of the detected beam. In an embodiment, the electronic device may control the antenna arrays such that directions of beams of the antenna arrays are the same as the direction of the detected beam.

In an embodiment, in the case where an electric field situation is excellent, the electronic device may allow a part of the antenna arrays to form a beam in a direction different from the direction of the detected beam. For example, in the case where a distance from another electronic device or a base station which the electronic device communicates with is sufficiently close, even though interference between transmit signals occurs, the electronic device may communicate with another electronic device or the base station by using a signal of a sufficient strength. In this case, the electronic device may form a beam of the part of the antenna arrays in a direction different from the direction of the detected beam.

According to an embodiment, the electronic device may be configured to transmit data in a plurality of directions by providing a first signal to be beamformed in a first direction to any one antenna array during a first period in time and providing a second signal to be beamformed in a second direction to another antenna array different from the one antenna array during a second period in time different from the first period in time.

Through the operations, the electronic device may form a beam and may transmit/receive data.

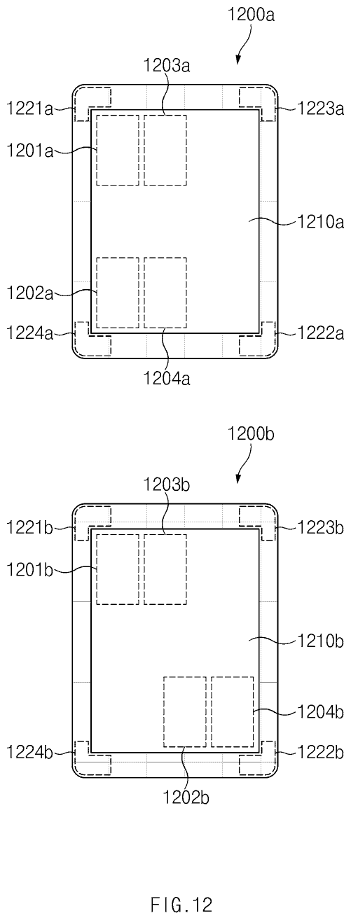

FIG. 12 is a view illustrating antenna arrangement of the electronic device according to various embodiments.

Referring to FIG. 12, antenna arrays of an electronic device may be arranged in various shapes.

According to an embodiment, an electronic device 1200a (e.g., the electronic device 101 of FIG. 1) may include a cover glass 1210a and antenna arrays 1201a, 1202a, 1203a, and 1204a. In an embodiment, the antenna arrays 1201a, 1202a, 1203a, and 1204a may be positioned adjacent to two corners which are adjacent to each other, when viewed from above the cover glass 1210a. In an embodiment, the first antenna array 1201a may be positioned adjacent to a first corner 1221a of the electronic device 1200a. The third antenna array 1203a may be positioned adjacent to the first antenna array 1201a. The second antenna array 1202a may be positioned adjacent to a fourth corner 1224a which is adjacent to the first corner 1221a of the electronic device 1200a. The fourth antenna array 1204a may be positioned adjacent to the second antenna array 1202a.

According to an embodiment, an electronic device 1200b may include a cover glass 1210b and antenna arrays 1201b, 1202b, 1203b, and 1204b. In an embodiment, the antenna arrays 1201b, 1202b, 1203b, and 1204b may be positioned adjacent to two corners which are placed at the opposite angles of a housing, when viewed from above the cover glass 1210b. In an embodiment, the first antenna array 1201b and the third antenna array 1203b may be positioned adjacent to a first corner 1221b of the electronic device 1200b. The second antenna array 1202b and the fourth antenna array 1204b may be positioned adjacent to a second corner 1222b which is in diagonal relationship with the first corner 1221b of the electronic device 1200b. In an embodiment, the first antenna array 1201b may be positioned adjacent to the third antenna array 1203b, and the second antenna array 1202b may be positioned adjacent to the fourth antenna array 1204b.

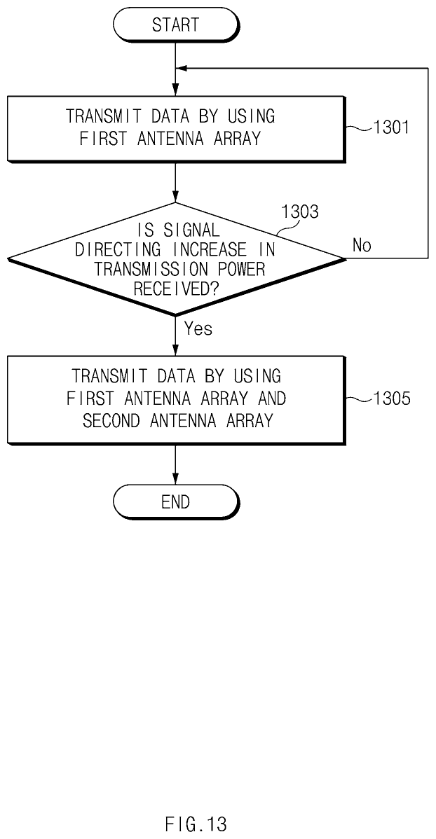

FIG. 13 is a flowchart illustrating an operation in which an electronic device transmits data, according to an embodiment.

Referring to FIG. 13, an operation in which an electronic device according to an embodiment transmits data may include operation 1301 to operation 1305. Operation 1301 to operation 1305 may be performed by, for example, the electronic device 101 illustrated in FIG. 1.

In operation 1301, the electronic device may transmit data by using a first antenna array. In an embodiment, the electronic device may transmit data by using the first antenna array as possible as a maximum power.

In operation 1303, the electronic device may determine whether to increase a transmission power of the data. For example, a base station may transmit a control signal to the electronic device such that the electronic device increases the transmission power. In an embodiment, in the case where the electronic device does not receive the control signal, the electronic device may repeat operation 1301. In an embodiment, in the case where the electronic device receives the control signal, the electronic device may perform operation 1305.

In the case where the electronic device receives a signal directing an increase in the transmission power, in operation 1305, the electronic device may transmit the data by using the first antenna array and a second antenna array. As the electronic device uses a plurality of antenna arrays at the same time, the electronic device may increase a beamforming gain and may increase the transmission power.

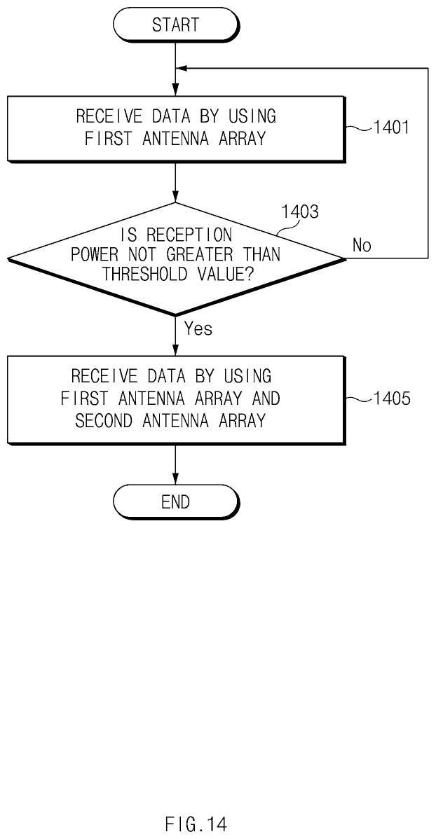

FIG. 14 is a flowchart illustrating an operation in which an electronic device receives data, according to an embodiment.

Referring to FIG. 14, an operation in which an electronic device according to an embodiment receives data may include operation 1401 to operation 1405. Operation 1401 to operation 1405 may be performed by, for example, the electronic device 101 illustrated in FIG. 1.

In operation 1401, the electronic device may receive data by using a first antenna array. In an embodiment, the electronic device may receive data by using the first antenna array as possible as a maximum power.

In operation 1403, the electronic device may determine the magnitude of a reception power. In an embodiment, in the case where the magnitude of the reception power of the electronic device is greater than a threshold value, the electronic device may repeat operation 1401. In an embodiment, in the case where the magnitude of the reception power of the electronic device is not greater than the threshold value, the electronic device may perform operation 1405.

In operation 1405, the electronic device may receive data by using the first antenna array and a second antenna array for the purpose of increasing the magnitude of the reception power. As the electronic device uses a plurality of antenna arrays at the same time, the electronic device may increase a beamforming gain and may increase the reception power.

As antenna arrays are positioned in diagonal relationship in consideration of a grip shape of the user, the electronic device according to various embodiments of the present disclosure may minimize the influence of a user's grip on the performance of the antenna. In other words, regardless of a grip shape of the user, the electronic device may secure antenna arrays which may transmit/receive first data and second data.

The electronic device according to various embodiments of the present disclosure may select an antenna array, which is not affected by the user's grip, from among a plurality of antenna arrays by using a grip sensor and/or a posture control sensor. the communication quality of the antenna array which is affected by the user's grip may be relatively bad, and the electronic device according to various embodiments of the present disclosure may increase the communication efficiency by selecting an antenna array of a good communication quality.

An electronic device according to an embodiment may include a housing that includes a cover glass formed in a substantial quadrangle, a rear plate having a shape corresponding to the cover glass and facing away from the cover glass, and a side member surrounding a space between the cover glass and the rear plate, a first antenna array that is positioned adjacent to a first corner of the side member within the housing and transmits/receives a first radio frequency (RF) signal corresponding to first data, a second antenna array that is positioned adjacent to a second corner of the side member within the housing and transmits/receives a second RF signal corresponding to the first data, a third antenna array that is positioned adjacent to a third corner of the side member within the housing and transmits/receives a third RF signal corresponding to second data, a fourth antenna array that is positioned adjacent to a fourth corner of the side member within the housing and transmits/receives a fourth RF signal corresponding to the second data, and a communication module that is positioned within the housing and is electrically connected with the first antenna array, the second antenna array, the third antenna array, and the fourth antenna array. The communication module may control at least one of the first antenna array, the second antenna array, the third antenna array, and the fourth antenna array such that at least one beam for transmitting/receiving at least one RF signal of the first RF signal, the second RF signal, the third RF signal, and the fourth RF signal is formed.

According to an embodiment, the first corner and the second corner may be in diagonal relationship, and the third corner and the fourth corner are in diagonal relationship.

According to an embodiment, each of the first antenna array, the second antenna array, the third antenna array, and the fourth antenna array may include a plurality of antenna elements. To form the at least one beam, the communication module may change a phase of at least one RF signal of the first RF signal, the second RF signal, the third RF signal, and the fourth RF signal, which the antenna elements transmit/receive.

According to an embodiment, the communication module may change a phase of at least one RF signal of the first RF signal, the second RF signal, the third RF signal, and the fourth RF signal in proportion to a gap between the antenna elements.

According to an embodiment, the communication module may change a phase of at least one RF signal of the first RF signal, the second RF signal, the third RF signal, and the fourth RF signal in proportion to a sine value of a direction angle of a main lobe of the beam.

According to an embodiment, the electronic device may further include at least one grip sensor configured to detect whether a grip of a user is made, and the communication module may select an antenna array which transmits/receives at least one of the first data and the second data, based on the detection result of the at least one grip sensor.

According to an embodiment, in the case where the detection result indicates that a region adjacent to the second corner and a region adjacent to the fourth corner are gripped in the electronic device, the communication module may select at least one of the first antenna array and the third antenna array for the purpose of transmitting/receiving at least one of the first data and the second data.

According to an embodiment, the electronic device may further include a posture detection sensor, and the communication module may select an antenna array which transmits/receives at least one of the first data and the second data, based on a posture detection result of the posture detection sensor.

According to an embodiment, in the case where a posture of the electronic device is detected as a posture in which the second corner and the fourth corner are closer to a ground than the first corner and the third corner, the communication module may select at least one of the first antenna array and the third antenna array for the purpose of transmitting/receiving at least one of the first data and the second data.

According to an embodiment, the posture detection sensor may include a gyro sensor, an acceleration sensor, or a geomagnetic sensor.

According to an embodiment, the electronic device may transmit/receive a plurality of RF signals of the first RF signal, the second RF signal, the third RF signal, and the fourth RF signal, and the communication module may control the first antenna array, the second antenna array, the third antenna array, and the fourth antenna array such that a plurality of beams for transmitting/receiving the plurality of RF signals are formed in the same direction.

According to an embodiment, the electronic device may transmit/receive at least one RF signal of the first RF signal, the second RF signal, the third RF signal, and the fourth RF signal in a time division duplex (TDD) manner.

According to an embodiment, the electronic device may receive a plurality of RF signals of the first RF signal, the second RF signal, the third RF signal, and the fourth RF signal, and the communication module may control the first antenna array, the second antenna array, the third antenna array, and the fourth antenna array such that a plurality of beams for receiving the plurality of RF signals are formed in different directions.

According to an embodiment, the electronic device may transmit a plurality of RF signals of the first RF signal, the second RF signal, the third RF signal, and the fourth RF signal; in the case where an electric field situation is not lower than a specified reference, the communication module may control the first antenna array, the second antenna array, the third antenna array, and the fourth antenna array such that a plurality of beams for transmitting the plurality of RF signals are formed in different directions; in the case where the electric field situation is lower than the specified reference, the communication module may control the first antenna array, the second antenna array, the third antenna array, and the fourth antenna array such that the plurality of beams for transmitting the plurality of RF signals are formed in the same direction.

According to an embodiment, the electric field situation may be determined based on at least one of a reference signals received power (RSRP), a reference signal received quality (RSRQ), a received signal strength index (RSSI), and a signal noise ratio (SNR).

According to an embodiment, the communication module may further include a first RF integrated circuit (RF IC), a second RF IC, a third RF IC, and a fourth RF IC. The first RF IC may process the first RF signal, the second RF IC may process the second RF signal, the third RF IC may process the third RF signal, and the fourth RF IC may process the fourth RF signal.

According to an embodiment, the communication module may further include an intermediate frequency integrated circuit (IF IC), and the IF IC may process a first IF signal which corresponds to the first RF signal and the second RF signal and a second IF signal which corresponds to the third RF signal and the fourth RF signal.

According to an embodiment, the IF IC may include a first combiner and a second combiner; when the electronic device is in a signal receive mode, the first combiner may integrate a signal processed by the first RF IC and a signal processed by the second RF IC, and the second combiner may integrate a signal processed by the third RF IC and a signal processed by the fourth RF IC.

According to an embodiment, the IF IC may include a first combiner and a second combiner; when the electronic device is in a signal transmit mode, the first combiner may divide the first IF signal so as to be provided to the first RF IC and the second RF IC, and the second combiner may divide the second IF signal so as to be provided to the third RF IC and the fourth RF IC.

According to an embodiment, at least one of the first antenna array, the second antenna array, the third antenna array, and the fourth antenna array may transmit/receive a signal in a frequency band including 28 GHz.

The electronic device according to various embodiments disclosed in the present disclosure may be various types of devices. The electronic device may include, for example, at least one of a portable communication device (e.g., a smartphone), a computer device, a portable multimedia device, a mobile medical appliance, a camera, a wearable device, or a home appliance. The electronic device according to an embodiment of the present disclosure should not be limited to the above-mentioned devices.

It should be understood that various embodiments of the present disclosure and terms used in the embodiments do not intend to limit technologies disclosed in the present disclosure to the particular forms disclosed herein; rather, the present disclosure should be construed to cover various modifications, equivalents, and/or alternatives of embodiments of the present disclosure. With regard to description of drawings, similar components may be assigned with similar reference numerals. As used herein, singular forms may include plural forms as well unless the context clearly indicates otherwise. In the present disclosure disclosed herein, the expressions “A or B”, “at least one of A or/and B”, “A, B, or C” or “one or more of A, B, or/and C”, and the like used herein may include any and all combinations of one or more of the associated listed items. The expressions “a first”, “a second”, “the first”, or “the second”, used in herein, may refer to various components regardless of the order and/or the importance, but do not limit the corresponding components. The above expressions are used merely for the purpose of distinguishing a component from the other components. It should be understood that when a component (e.g., a first component) is referred to as being (operatively or communicatively) “connected,” or “coupled,” to another component (e.g., a second component), it may be directly connected or coupled directly to the other component or any other component (e.g., a third component) may be interposed between them.

The term “module” used herein may represent, for example, a unit including one or more combinations of hardware, software and firmware. The term “module” may be interchangeably used with the terms “logic”, “logical block”, “part” and “circuit”. The “module” may be a minimum unit of an integrated part or may be a part thereof. The “module” may be a minimum unit for performing one or more functions or a part thereof. For example, the “module” may include an application-specific integrated circuit (ASIC).

Various embodiments of the present disclosure may be implemented by software (e.g., the program 140) including an instruction stored in a machine-readable storage media (e.g., an internal memory 136 or an external memory 138) readable by a machine (e.g., a computer). The machine may be a device that calls the instruction from the machine-readable storage media and operates depending on the called instruction and may include the electronic device (e.g., the electronic device 101). When the instruction is executed by the processor (e.g., the processor 120), the processor may perform a function corresponding to the instruction directly or using other components under the control of the processor. The instruction may include a code generated or executed by a compiler or an interpreter. The machine-readable storage media may be provided in the form of non-transitory storage media. Here, the term “non-transitory”, as used herein, is a limitation of the medium itself (i.e., tangible, not a signal) as opposed to a limitation on data storage persistency.

According to an embodiment, the method according to various embodiments disclosed in the present disclosure may be provided as a part of a computer program product. The computer program product may be traded between a seller and a buyer as a product. The computer program product may be distributed in the form of machine-readable storage medium (e.g., a compact disc read only memory (CD-ROM)) or may be distributed only through an application store (e.g., a Play Store™). In the case of online distribution, at least a portion of the computer program product may be temporarily stored or generated in a storage medium such as a memory of a manufacturer's server, an application store's server, or a relay server.

Each component (e.g., the module or the program) according to various embodiments may include at least one of the above components, and a portion of the above sub-components may be omitted, or additional other sub-components may be further included. Alternatively or additionally, some components (e.g., the module or the program) may be integrated in one component and may perform the same or similar functions performed by each corresponding components prior to the integration. Operations performed by a module, a programming, or other components according to various embodiments of the present disclosure may be executed sequentially, in parallel, repeatedly, or in a heuristic method. Also, at least some operations may be executed in different sequences, omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. An electronic device comprising:
a housing including a cover glass formed in a substantial quadrangle, a rear plate having a shape corresponding to the cover glass and facing away from the cover glass, and a side member surrounding a space between the cover glass and the rear plate;
a first antenna array positioned adjacent to a first corner of the side member within the housing and configured to transmit/receive a first radio frequency (RF) signal corresponding to first data;
a second antenna array positioned adjacent to a second corner of the side member within the housing and configured to transmit/receive a second RF signal corresponding to the first data;
a third antenna array positioned adjacent to a third corner of the side member within the housing and configured to transmit/receive a third RF signal corresponding to second data;
a fourth antenna array positioned adjacent to a fourth corner of the side member within the housing and configured to transmit/receive a fourth RF signal corresponding to the second data; and
a communication module positioned within the housing and electrically connected with the first antenna array, the second antenna array, the third antenna array, and the fourth antenna array,
wherein the communication module is configured to:
control at least one of the first antenna array, the second antenna array, the third antenna array, and the fourth antenna array such that at least one beam for transmitting/receiving at least one RF signal of the first RF signal, the second RF signal, the third RF signal, and the fourth RF signal is formed.

2. The electronic device of claim 1, wherein the first corner and the second corner are in diagonal relationship, and the third corner and the fourth corner are in diagonal relationship.

3. The electronic device of claim 1,
wherein each of the first antenna array, the second antenna array, the third antenna array, and the fourth antenna array includes a plurality of antenna elements, and
wherein, to form the at least one beam, the communication module changes a phase of at least one RF signal of the first RF signal, the second RF signal, the third RF signal, and the fourth RF signal, which the antenna elements transmit/receive.

4. The electronic device of claim 3, wherein the communication module changes a phase of at least one RF signal of the first RF signal, the second RF signal, the third RF signal, and the fourth RF signal in proportion to a gap between the antenna elements.

5. The electronic device of claim 3, wherein the communication module changes a phase of at least one RF signal of the first RF signal, the second RF signal, the third RF signal, and the fourth RF signal in proportion to a sine value of a direction angle of a main lobe of the beam.

6. The electronic device of claim 1, further comprising:
at least one grip sensor configured to detect whether a grip of a user is made,
wherein the communication module selects an antenna array which transmits/receives at least one of the first data and the second data, based on the detection result of the at least one grip sensor.

7. The electronic device of claim 6, wherein, in the case where the detection result indicates that a region adjacent to the second corner and a region adjacent to the fourth corner are gripped in the electronic device, the communication module selects at least one of the first antenna array and the third antenna array for the purpose of transmitting/receiving at least one of the first data and the second data.

8. The electronic device of claim 1, further comprising:
a posture detection sensor,
wherein the communication module selects an antenna array which transmits/receives at least one of the first data and the second data, based on a posture detection result of the posture detection sensor.

9. The electronic device of claim 8, wherein, in the case where a posture of the electronic device is detected as a posture in which the second corner and the fourth corner are closer to a ground than the first corner and the third corner, the communication module selects at least one of the first antenna array and the third antenna array for the purpose of transmitting/receiving at least one of the first data and the second data.

10. The electronic device of claim 8, wherein the posture detection sensor includes a gyro sensor, an acceleration sensor, or a geomagnetic sensor.

11. The electronic device of claim 1,
wherein the electronic device is configured to transmit/receive a plurality of RF signals of the first RF signal, the second RF signal, the third RF signal, and the fourth RF signal, and
wherein the communication module controls the first antenna array, the second antenna array, the third antenna array, and the fourth antenna array such that a plurality of beams for transmitting/receiving the plurality of RF signals are formed in the same direction.

12. The electronic device of claim 1, wherein the electronic device transmits/receives at least one RF signal of the first RF signal, the second RF signal, the third RF signal, and the fourth RF signal in a time division duplex (TDD) manner.

13. The electronic device of claim 12,
wherein the electronic device is configured to receive a plurality of RF signals of the first RF signal, the second RF signal, the third RF signal, and the fourth RF signal, and
wherein the communication module controls the first antenna array, the second antenna array, the third antenna array, and the fourth antenna array such that a plurality of beams for receiving the plurality of RF signals are formed in different directions.

14. The electronic device of claim 12,
wherein the electronic device is configured to transmit a plurality of RF signals of the first RF signal, the second RF signal, the third RF signal, and the fourth RF signal,
wherein, in the case where an electric field situation is not lower than a specified reference, the communication module controls the first antenna array, the second antenna array, the third antenna array, and the fourth antenna array such that a plurality of beams for transmitting the plurality of RF signals are formed in different directions, and
wherein, in the case where the electric field situation is lower than the specified reference, the communication module controls the first antenna array, the second antenna array, the third antenna array, and the fourth antenna array such that the plurality of beams for transmitting the plurality of RF signals are formed in the same direction.

15. The electronic device of claim 14, wherein the electric field situation is determined based on at least one of a reference signals received power (RSRP), a reference signal received quality (RSRQ), a received signal strength index (RSSI), and a signal noise ratio (SNR).
